(19) United States
(12) Patent Application Publication
(10) Pub. No.: US 2014/0269910 A1
(43) Pub. Date: Sep. 18, 2014

(54) METHOD AND APPARATUS FOR USER GUIDED PRE-FILTERING

(71) Applicant: SRI INTERNATIONAL, Menlo Park, CA (US)

(72) Inventor: Sek Chai, Princeton, NJ (US)

(73) Assignee: SRI INTERNATIONAL, Menlo Park, CA (US)

(21) Appl. No.: 13/840,600

(22) Filed: Mar. 15, 2013

(51) Int. Cl. H04N 19/117; H04N 19/80

(52) U.S. Cl. CPC H04N 19/00066; H04N 19/0089
USPC 375/240.06; 375/240.29

(57) ABSTRACT

A method and apparatus for user guided pre-filtering of video content comprising modifying one or more parameters of a pre-filter coupled to a video encoder based on feedback from a user of a device displaying the video content, applying the pre-filter to video content based on the modified parameters and encoding the pre-filtered video content for transmission over a network to display on the device.

### CROSS-REFERENCE TO RELATED APPLICATIONS

The present invention is related to commonly assigned and co-pending U.S. patent application Ser. No. ______ attorney docket number SRI6628. Each of the aforementioned patent applications is herein incorporated in its entirety by reference.

### BACKGROUND OF THE INVENTION

1. Field of the Invention

Embodiments of the present invention generally relate to salience based compression and video transmission and, more particularly, to a method and apparatus for user guided pre-filtering.

2. Description of the Related Art

Technologies such as vision guided compression (VGC) or salience based compression (SBC) are often used to perform compression on video content to reduce bit rate so as to reduce network bandwidth requirements by preserving important and actionable details in the original video content in salient regions at the cost of discarding “unimportant” detail in non-salient regions. However, standard VGC/SBC methods do not address a network's variable bandwidth or delivering actionable video on very low bandwidth networks and therefore video streaming may be interrupted or distorted. Current VGC/SBC implementations also do not address human reception of pre-filtered video. For example pre-filtered video destined for human viewing does not allow for human interaction and feedback on the video content to affect encoding and pre-filtering parameters.

Therefore, there is a need in the art for a method and apparatus for user guided pre-filtering to perform video encoding for low and variable band-width networks.

### SUMMARY OF THE INVENTION

An apparatus and/or method for user guided pre-filtering of video content, substantially as shown in and/or described in connection with at least one of the figures, as set forth more completely in the claims.

Various advantages, aspects and features of the present disclosure, as well as details of an illustrated embodiment thereof, are more fully understood from the following description and drawings.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a functional block diagram of an adaptive filter module in accordance with exemplary embodiments of the present invention;

FIG. 2 is an illustration of the impact of the adaptive filter module on a sample frame of video content in accordance with an exemplary embodiment of the present invention;

FIG. 3 is an illustration of the result of the pixel propagation module in accordance with exemplary embodiments of the present invention;

FIG. 4 depicts a computer in accordance with at least one embodiment of the present invention;

FIG. 5 depicts a flow diagram of a method for modifying bit-rate of video content in accordance with embodiments of the present invention; and

FIG. 6 depicts a flow diagram of a method for modifying bit-rate of video content in accordance with embodiments of the present invention.

### DETAILED DESCRIPTION

Embodiments of the present invention generally relate to vision and network guided pre-filtering. According to one embodiment, an encoder encodes video for transmission over a network and a decoder receives the video and decodes the video for displaying, storage or the like. Once a user of a mobile device, tablet device, or the like, views the video content, the user provides dynamic feedback to modify pre-filter parameters to affect prefilter processing.

FIG. 1 depicts a functional block diagram of an adaptive filter module 100 in accordance with exemplary embodiments of the present invention. An image sensor 102 senses and captures video or images of a scene (not shown). The video or image content can also optionally be stored in an image and video database 103, or stored in another form of external or internal storage. The image sensor 102, for example, records the video at a particular bit-rate, in such formats as MPEG-1 (H.261), MPEG-2 (H.262), MPEG-4/AVC (H.264) and MPEG HEVC (H.265), or the like. The originally captured frames may be in high definition (HD) or standard definition (SD), where even standard definition frames of a video may be several megabytes in size. The HD frames of video are significantly larger and occupy more storage space as well as require more bandwidth when being transmitted.

For example, for a video composed of SD frames, an acceptable target bit-rate may be 1-5 Mbps, whereas an HD video stream requires as much as a 10-18 Mbps capable network to transmit video streams at their desired clarity. For commonly used networks such as network 101, such large bandwidth requirements are impractical and therefore, a vision processor 104 is embedded between the image sensor 102 and a video encoder 106. Typical networks may include RF channels which have an approximate bandwidth of approximately 20 Megabits per second (Mbps), IP networks which have an approximate bandwidth of approximately 0.1 to 5 Mbps, and the like.

The vision processor 104 further comprises a pre-filter 105. The vision processor 104 applies vision guided compression (VGC) and salience based compression (SBC) to the video content in order to reduce the bit-rate and compress the video content to a manageable size without losing important details. The vision pre-filter 105 performs salience based blurring or other functions on the video content. For example, if the video content contains two moving objects on a background, the moving objects are detected and regarded as salient, and the rest of the background is considered non-salient.

The non-salient regions are then blurred or filtered, by various filters such as a Gaussian filter, a boxcar filter, a pillbox filter, or the like, removing a significant amount of unimportant detail that would have been compressed. For further detail regarding SBC and VGC, please see U.S. patent application Ser. No. 12/644,707 entitled “High-Quality Region-Of-Interest Compression using commercial Off-The-Shelf encoders”, filed on Dec. 22, 2009, hereby incorporated by reference in its entirety.

The video encoder 106 encodes the compressed video content using the codecs mentioned above such as MPEG2/MPEG4 or the like. The video encoder 106 further comprises a pre-filter 107 which performs pixel by pixel filtering, and does not take into account spatial attributes of the video content, as opposed to the vision processor 104. The video encoder 106 is a standard off-the-shelf video encoder. The video encoder encodes the video in order to transmit the video at a particular bit-rate over the network 101.

In order for the video content to be viewed, it must first be decoded by the video decoder 108. As with the video encoder 106, the video decoder 108 is a standard off-the-shelf video decoder capable of decoding standard video formats such as MPEG1-4. Once the decoder decodes the video content, the content is streamed or transmitted to a display 110, or to a storage database 112. According to other embodiments, the video decoder 108 can couple the video content with any end user consuming device such as a tablet, a mobile phone, a television, or the like. The display 110 is coupled to a user interface 114, which allows a user of the display 110 to provide dynamic feedback to the adaptive filter module 100. The user interface 114 may be displayed on a touch-based mobile device, for example, a smart-phone or tablet, in which the region of interest drives the inset location or adds a new feature to be tracked and kept salient in the vision processor 104 based on, for example, where a user's touch input is detected.

According to some other instances, the user interface 114 is a vision-based system, where the image sensor 102 captures images in a location remote from the vision processor 104. The vision processor 104 is used to process the captured images and generate “mask” information for the vision processor 104, i.e., masking the areas to be filtered. The user interface 114, according to this embodiment, includes a latency adjustment module 115 that uses network traffic information to alter the mask information. For example, if there is high latency through the network 101, the mask information may take additional time to reach the vision processor 104. In this case, the latency adjustment module 115 can process predictive mask information. For example, if the vision processing tracks motion of the gaze of the user in order to generate the mask information, the latency adjustment module 115 can include a prediction of where the gaze would be in a few moments.

According to some embodiments, the user interface is coupled to a gaze tracking system where a user's face is tracked, and gaze location is determined. If a user is looking at a top corner of the image on the display, the location information (top corner) is used to generate mask information that affects the vision processor 104. The vision processor 104 would pre-filter the source image whereby the top-corner location is considered salient. Changes in the user's gaze would change the location of a salient inset location.

According to another embodiment, the user interface 114 is coupled to a remote system comprising a two-way video conferencing system including a camera in a conference area that also operates as a gaze tracker. The gaze tracker provides feedback to the vision processor 104 via the adaptive filter module 100. A user in such a system looking at a particular object in a conference area will see un-filtered regions where the users gaze is focused. Thus, a video source other than the image sensor 102 is used to supply the image from which the mask is generated to affect the pre-filter 105 of the vision processor 104 through the adaptive filter module 100. In one embodiment the sensor modality of the video source used to drive the mask generation may be different than the sensor modality of video source 102, such as an infrared (IR) sensor modality.

In another embodiment, the user interface 114 is coupled to an iris recognition system or face recognition system, in which the identity of a viewer is determined. The user interface 114 pre-filters a selected region of the image because the user's attention is not directed at that particular area of that image. In another embodiment, the user interface 114 can pre-filter a selected region of the image because the user might not have access to particular information. For example, the selected region of the image can be pre-filtered to conceal the identity of an object or person. The selected region of the image can also be pre-filtered to conceal objects, such as signs and the like, to conceal information that reveals the location of the image. In a related embodiment, multiple users are detected at different remote locations, and different salient regions can be selected for different users. In yet another embodiment, multiple users are detected in the same remote location, and salient requirements are set based on viewing angle. For example, in a 3D HDTV display, different salient regions can affect the viewing experience based on the pre-filtering of video content.

According to other embodiments, the user interface 114 controls the feedback to incorporate the duration of a user's gaze, affecting the level and type of pre-filtering over time. In other instances, the user interface 114 modifies the feedback to the adaptive filter module 100 based on the expression of a user of the user interface 114 to select salient regions. User movement is also incorporated into the feedback of the user interface 114 to affect parameters of the vision processor 104 and the pre-filter 105. For example, if a user is in motion, a higher level of pre-filtering is used (i.e., higher blur) because the user would be unable to perceive the difference in levels of pre-filtering due to his or her motion.

In a closed network, a feedback path is present between the user interface 114 and the vision processor 104, as well as between the video decoder 108 and the vision processor 104. The video decoder 108 receives information about network bandwidth changes, vision and gaze changes, user movement, and the like and couples with the adaptive filter module 100 to send a message to the vision processor 104 concerning modifying the parameters of the pre-filter 105.

The adaptive filter module 100 then determines how the vision processor 104 and the pre-filter 105 will be modified to increase or decrease the bit-rate depending on the user feedback from the user interface 114. The adaptive filter module 100 may, according to one embodiment, request that the pre-filter 105 modify the type of filter being applied, for example, a boxcar, a Gaussian filter or a pillbox filter. According to other embodiments, the filter size is modified. For example, a smaller or larger region is filtered according to salient region selection. According to another embodiment, the number of salient objects being filtered is modified according to location, size of objects, amount of motion, or the like. According to yet another embodiment, the adaptive filter module 100 requests that the vision processor 104 and the pre-filter 105 vary the rate in which the filter is applied to salient objects. The degree of low-pass filtering applied to non-salient pixels in a frame greatly affects the bit rate. For a given low-pass filter shape, the degree of filtering increases with filter size.

For example, for a box-car filter applied to video processed by a binary salience map drastically reduces the bit-rate as the filter increases in size. For example, a 640×480 pixel video running at 30 frames per second is filtered with a boxcar filter and encoded in “constant quality” mode using H.264/MPEG-4 AVC video compression. In constant quality mode, the quantization parameter (QP) stays fixed, and bits are produced in proportion to the underlying entropy of the video signal. As QP increases, more transform coefficients are quantized to zero, and fewer coded bits per image block are produced. Major drops in bit rate, independent of QP, occur as the boxcar size increases from 1×1 to 5×5, with diminishing returns thereafter. Boxcar sizes larger than 9×9 show almost no additional drop in bit rate. The resulting bit rate is approximated as a weighted average of the two external bit rates produced when all pixels are filtered by each of the filters individually:

BR=W*BRmax+(1−W)*BRmin (1)

where BRmax is the bit rate produced by filtering all pixels with the salient, on “inside”, filter; BRmin is the bit rate produced by filtering all pixels with the non-salient, on “outside”, filter; and W, the weighting parameter, is equal to the fraction of salient pixels in the frame. In this example, when video is filtered with a 1×1 boxcar (i.e., is not filtered at all) and encoded in constant quality mode with QP=20, the resulting bit rate is BRmax=8 Mbps. When the same video is filtered with an 11×11 boxcar and encoded in constant quality mode with QP=20, the resulting bit rate is BRmin=1 Mbps. When the fraction of salient pixels in the frame is 10% (W=0.1), the resulting bit rate is approximately BR=0.1*8+0.9*1=1.7 Mbps, a point that is plotted on the dashed line. As W approaches 1.0, BR approaches BRmax; as W approaches 0.0, BR approaches BRmin.

Accordingly, increasing the filter size lowers the bit rate. For instance, if the channel bit rate is 3 Mbps, a 3×3 boxcar filter is used; however, if the channel bit rate drops to 1 Mbps, an 11×11 boxcar filter is selected. Doing so increases the blur of the non-salient pixels but minimally affects the quality of the salient pixels.

Generally speaking, the bit rate is modeled verses a filter size curve as in the following exponential function:

r(s)=a·e−bs+c (2)

where r is the rate in bits per second (bps), s is the filter size (in pixels) and a, b, and c are known, non-negative, measured constants that are a function of image format and content. For a two-level salience map, the rate R produced by filtering some non-negative fractional of the pixels with size s1 and the complementary non-negative fraction α2=1−α1 with size s2 is given by:

R=α1r(s1)+α2r(s2)=[α·a·exp(−bs1)+c]+[a2·a·exp(−bs2)+c] (3)

We know R, α1, α2, a, b and c, so the equation reduces to

C=α1×1+α2×2 (4)

where C=(R−2c)/a and xi=αi·exp(−bsi) for i=1,2. This is a linear equation in x1,x2 so any two values satisfying the equation can be picked. Once they are picked, the filter sizes are obtained as follows:

si=−ln(xi/αi)/b for i=1,2 (5)

Although this is for the two-level saliency case (N=2), it is easy to generalize this method to the N-level saliency case, where N>2. Filter sizes and filter kernels can either be generated adaptively or pre-computed and stored in a look-up table stored in the adaptive filter module 100. According to an exemplary embodiment, filter sizes increase as network bandwidth decreases, and less filtering is done in salient regions compared to non-salient regions.

According to other embodiments, the adaptive filter module 100 may also comprise a pixel propagation module 116, which may be directly coupled with the image sensor 102, the image and video database 103, the vision processor 104 an the video encoder 106. In some instances, the pixel propagation module 116 can be used independently of the adaptive filter module 100.

According to one embodiment, the pixel propagation module 116 receives video content from the image sensor 102, for example, and analysis frame to frame movement in the captured video content. In scenes where the sensor 102 view is relatively fixed, but there is some movement of the sensor 102, video stabilization is initially performed in order to align the frames in the video content. Once the frames are aligned, the pixel propagation module 116 analyzes frame to frame pixel differences in the video content and determines the pixels which remain static are “non-salient” in the sense that they do not need to be represented in each frame.

The pixel propagation module 116 then propagates the pixels found in the initial frame to the other frames which share an overlapping view of the initial frame. When the vision processor 104, or the video encoder 106 directly performs compression on the video content and achieve a great compression ratio because each of the frames are essentially composed of the same pixels, excluding any moving object pixels. The highly compressed video content can then be encoded at a significantly lower bit-rate and can therefore be transmitted over low bandwidth networks. The video is decoded by video decoder 108 and displayed on display 110 with most of the background remaining static while only foreground, or salient, objects are in motion.

FIG. 2 is an illustration of the impact of the adaptive filter module 100 on a sample frame of video content in accordance to an exemplary embodiment of the present invention. Illustration 200 depicts the typical scenario where an image frame 202 comprises a torso 206, a head 208 and a background 210. The vision processor 104 is applied to the frame of the video content to produce a salience detected image where the torso 206 and the head 208 are selected as salient and the background 210 is selected as non-salient by a user of the user interface 114. The background 210 has had a filter applied to it, for example, a Gaussian blur, in order to reduce the amount of detail shown, whereas the torso 206 and the head 208 are maintained at their current fidelity or sharpened.

However, when the adaptive filter module 100 receives user feedback from the user interface 114 that salient regions have changed, the vision processor 104 behaves differently. According to this embodiment, illustration 207 shows a frame 201 which is the same as frame 202 being processed by the vision processor 104, but the output image 214 has produced only one salient object: the head 208. The vision processor has filtered the torso 206 and the background 210 by, according to one embodiment, reducing the number of salient objects to be produced by the vision processor 104, where the only salient object is the head 208. In this embodiment, when the decoder decodes the video content and displays the frame 214 on a display, the body and background will be blurred and the foreground face 208 will be sharp.

FIG. 3 depicts computers 300 and 350 in accordance with at least one embodiment of the present invention for implementing the functional block diagram illustrated in FIG. 1. The computer 300 includes a processor 302, various support circuits 306, and memory 304. The processor 302 may include one or more microprocessors known in the art. The support circuits 306 for the processor 302 include conventional cache, power supplies, clock circuits, data registers, I/O interface 307, and the like. The I/O interface 307 may be directly coupled to the memory 304 or coupled through the supporting circuits 306. The I/O interface 307 may also be configured for communication with input devices and/or output devices 308 such as network devices, various storage devices, mouse, keyboard, display, video and audio sensors, IMU and the like.

The memory 304, or computer readable medium, stores non-transient processor-executable instructions and/or data that may be executed by and/or used by the processor 302. These processor-executable instructions may comprise firmware, software, and the like, or some combination thereof. Modules having processor-executable instructions that are stored in the memory 304 comprise a vision processing module 310, an adaptive filter module 314 and a pixel propagation module 316. The vision processing module 310 further comprises a pre-filter 312. According to some embodiments, the propagation module 316 may be a portion of the adaptive filter module 314.

The computer 300 may be programmed with one or more operating systems (generally referred to as operating system (OS)), which may include OS/2, Java Virtual Machine, Linux, SOLARIS, UNIX, HPUX, AIX, WINDOWS, WINDOWS95, WINDOWS98, WINDOWS NT, AND WINDOWS2000, WINDOWS ME, WINDOWS XP, WINDOWS SERVER, WINDOWS 8, IOS, ANDROID among other known platforms. At least a portion of the operating system may be disposed in the memory 304.

The memory 304 may include one or more of the following random access memory, read only memory, magneto-resistive read/write memory, optical read/write memory, cache memory, magnetic read/write memory, and the like, as well as signal-bearing media as described below.

The computer 300 may be coupled to computer 350 for implementing the user interface 114. The computer 350 includes a processor 352, various support circuits 356, and memory 354. The processor 352 may include one or more microprocessors known in the art. The support circuits 356 for the processor 352 include conventional cache, power supplies, clock circuits, data registers, I/O interface 357, and the like. The I/O interface 357 may be directly coupled to the memory 354 or coupled through the supporting circuits 356. The I/O interface 357 may also be configured for communication with input devices and/or output devices (not specifically shown) such as network devices, various storage devices, mouse, keyboard, display, video and audio sensors, IMU and the like.

The memory 354, or computer readable medium, stores non-transient processor-executable instructions and/or data that may be executed by and/or used by the processor 352. These processor-executable instructions may comprise firmware, software, and the like, or some combination thereof. Modules having processor-executable instructions that are stored in the memory 354 comprise a user interface 360, which further comprises a latency adjustment module 362.

The computer 350 may be programmed with one or more operating systems (generally referred to as operating system (OS)), which may include OS/2, Java Virtual Machine, Linux, SOLARIS, UNIX, HPUX, AIX, WINDOWS, WINDOWS95, WINDOWS98, WINDOWS NT, AND WINDOWS2000, WINDOWS ME, WINDOWS XP, WINDOWS SERVER, WINDOWS 8, IOS, ANDROID among other known platforms. At least a portion of the operating system may be disposed in the memory 354.

The memory 354 may include one or more of the following random access memory, read only memory, magneto-resistive read/write memory, optical read/write memory, cache memory, magnetic read/write memory, and the like, as well as signal-bearing media as described below.

FIG. 4 depicts a flow diagram of a method 400 for user guided pre-filtering of video content in accordance with embodiments of the present invention. The method 400 is an implementation of the user interface module 360 and the vision processing module 310 as executed by the processor 452 and processor 302, respectively, as shown in FIG. 4.

The method begins at step 402 and proceeds to step 404. At step 404, the method receives feedback from a user interface coupled to the device displaying the video content. The feedback may be user initiated, or automatically detected by the device itself. For example, a user can indicate by tactile interaction with the user interface or display device salient and non-salient regions in the video content, or the device can track user gaze to determine salient and non-salient regions based. The device may also monitor user motion as an indicator of attentiveness, to create the feedback information. At step 406, one or more parameters of the pre-filter are modified based on the user feedback. At step 408, the pre-filter is applied to the video content, and the video content is encoded to transmit over the network to the display device. The method terminates at step 410.

Various elements, devices, modules and circuits are described above in association with their respective functions. These elements, devices, modules and circuits are considered means for performing their respective functions as described herein. While the foregoing is directed to embodiments of the present invention, other and further embodiments of the invention may be devised without departing from the basic scope thereof, and the scope thereof is determined by the claims that follow.

1. A method for user guided pre-filtering of video content comprising:
modifying one or more parameters of a pre-filter coupled to a video encoder based on feedback from a user of a device displaying the video content;
applying the pre-filter to video content based on the modified parameters; and
encoding the pre-filtered video content for transmission over a network to display on the device.

2. The method of claim 1 further comprising:
selecting salient and non-salient regions based on user gaze and modifying the parameters of the pre-filter based on the selection,
wherein the device comprises an image sensor for capturing the gaze of a user.

3. The method of claim 1 further comprising:
wherein a user interface of the device for providing the feedback is remotely provided relative to the applying of the pre-filter and encoding of the pre-filtered video.

4. The method of claim 1 further comprising:
detecting user movement and modifying the parameters of the pre-filter based on the magnitude of the user motion.

5. The method of claim 1 further comprising:
wherein the encoding the pre-filtered video is performed by a standard video encoder.

6. The method of claim 1 further comprising:
selecting one or more salient regions based on the location of multiple users of the device.

7. The method of claim 1 further comprising:
wherein the parameters of the pre-filter comprise at least one of filter type, filter size, number of salient objects, rate of filter application to the salient objects, saliency regions and bit-rate.

8. The method of claim 1 further comprising:
providing available modifiable parameters to the user on the user device; and
allowing modification of the parameters from the device.

9. The method of claim 1 further comprising:
increasing pre-filtering to a predetermined limit when bandwidth of the network decreases, so as to decrease a bit-rate of the video content; and
decreasing pre-filtering when bandwidth of the network increases, so as to decrease a bit-rate of the video content.

10. The method of claim 2 further comprising:
measuring duration of the user gaze; and
modifying the feedback and pre-filtering parameters based on the duration.

11. An apparatus for user guided pre-filtering of video content comprising:
a user interface, executed on a device, for modifying one or more parameters of a pre-filter coupled to a video encoder based on feedback from a user of the device displaying the video content;
a video processor for applying the pre-filter to video content based on the modified parameters; and
a video encoder for encoding the pre-filtered video content for transmission over a network to display on the device.

12. The apparatus of claim 11 further comprising:
selecting salient and non-salient regions based on user gaze and modifying the parameters of the pre-filter based on the selection,
wherein the device comprises an image sensor for capturing the gaze of a user.

13. The apparatus of claim 11, wherein a user interface of the device for providing the feedback is provided remotely relative to the applying of the pre-filter and encoding of the pre-filtered video.

14. The apparatus of claim 11 wherein the device is further configured for:
detecting user movement and modifying the parameters of the pre-filter based on the magnitude of the user motion.

15. The apparatus of claim 11 wherein encoding the pre-filtered video is performed by a standard video encoder.

16. The apparatus of claim 11 wherein the device is further configured for:
selecting various salient regions based on multiple users of the device.

17. The apparatus of claim 11 further comprising:
wherein the parameters comprise at least one of filter type, filter size, number of salient objects, rate of filter application to the salient objects, saliency regions and bit-rate.

18. The apparatus of claim 11 wherein the device is further configured for:
providing available modifiable parameters to the user on the user device; and
allowing modification of the parameters from the device.

19. The apparatus of claim 11 wherein the device is further configured for:
increasing pre-filtering to a predetermined limit when the bandwidth decreases, so as to decrease a bit-rate of the video content; and
decreasing pre-filtering when the bandwidth increases, so as to decrease a bit-rate of the video content.

20. The apparatus of claim 18 wherein the device is further configured for:
measuring duration of the user gaze; and
modifying the feedback and pre-filtering parameters based on the duration.
